(19) United States
(12) Patent Application Publication
(10) Pub. No.: US 2014/0040724 A1
(43) Pub. Date: Feb. 6, 2014

(54) METHOD AND SYSTEM FOR WEBSITE CREATION

(71) Applicant: Minds and Machines, LLC, Santa Monica, CA (US)

(72) Inventor: Frederick R. Krueger, Santa Monica, CA (US)

(73) Assignee: Minds and Machines, LLC, Santa Monica, CA (US)

(21) Appl. No.: 13/957,385

(22) Filed: Aug. 1, 2013

Related U.S. Application Data
(60) Provisional application No. 61/678,261, filed on Aug. 1, 2012.

(51) Int. Cl. G06F 17/21

(52) U.S. Cl. CPC G06F 17/212
USPC 715/234

(57) ABSTRACT

Described is a system and method for creating and editing a theme of individual widgets through the use of child widgets.

### CROSS REFERENCE TO RELATED APPLICATIONS

This application claims priority to and all the benefits of U.S. Provisional Application No. 61/678,261, filed Aug. 1, 2012, and entitled “Method and System for Website Creation.”

### SUMMARY OF INVENTION WITH BACKGROUND INFORMATION

The present invention relates generally to website creation software and utilities, and more specifically to the use of themes in website creation. Even more specifically, embodiments of the invention implement parent widgets and child widgets in the creation of a website theme.

Widget-based website builders have several advantages. Such applications, including (without limitation) Wix.com, Yola.com, SnapPages.com, Moonfruit.com, SiteKreator.com, Cubender.com, Weebly.com, Goodsie.com, Webs.com, and SquareSpace.com have become highly popular as a means of creating and updating websites. Each of these website builders allows a site to be organized into a series of one or more pages. Each page consists of an assemblage of one or more widgets into one or more pre-defined regions.

One example of such a widget based layout is shown in FIG. 1. In FIG. 1, there are 4 regions: a header, a footer, a right sidebar and main area to the left of the sidebar. Each of these areas contains one widget: The header contains a logo widget, the main area contains a grid widget, and the footer and sidebar both contain text widgets.

For each widget, a property palette typically controls the look, feel, and other properties of that widget. For example, as shown in FIG. 2, a text widget might have properties including the font face text color and background color. By providing a wide array of widgets, each of which has a wide array of properties, these website builders allow the user to build a reasonably large variety of websites.

However, many of the more complex elements such as e-commerce grids, blog elements and the like are difficult to describe in a simple property palette. For example, a grid item element might have an image in landscape mode or in portrait mode. The text might be above or below the image. The alignment of the text might be left aligned or right aligned.

This presents a dilemma for creators of website building software. If one removes many of the options, the resulting array of choices becomes too small and all the sites that can be produced tend to resemble each other. On the other hand, offering hundreds of parameters and choices is a confusing and difficult user experience and ultimately is still too limiting.

To address this dilemma, site builders rely on the notion of external themes to define the look and feel of the more complex widgets and other page elements. These themes may be coded in a combination of markup and scripting languages including (without limitation) HTML, JavaScript, CSS and PHP. Because the themes are individually coded, they can produce a wide variety of effects—however, these effects are not modifiable by average users who are not skilled in the art of programming As can be seen in FIG. 3, these themes may be extremely complex and beyond the ability of average users to modify.

A further problem is that themes are typically site-wide. One theme might have a menu that is acceptable, but a grid that is too small for a specific user application. An alternative theme might have an acceptable grid, but a menu without the proper configuration options. As a consequence, selecting an overall theme is a hit and miss proposition.

Another disadvantage relating to the use of themes is that different themes can have different associated properties. For example, one theme might have a “site background color” setting, while another theme might not. This implies that as a user changes themes, any modifications made to the previous theme are lost.

The present inventive system and method relates to the design and definition of visual “widgets” for a hosted website, online photo gallery, or online store. As used herein, a widget is a software application that can be installed and executed within a page of a website by a user. For ease of reference, any one of a hosted website, an online photo gallery, or an online store will be referred to herein as a “website”. However, it should be understood that the term “website” may refer to any one of a hosted website, an online photo gallery, or an online store.

### BRIEF DESCRIPTION OF THE DRAWINGS

FIG. 1 is one example of a widget-based web page.

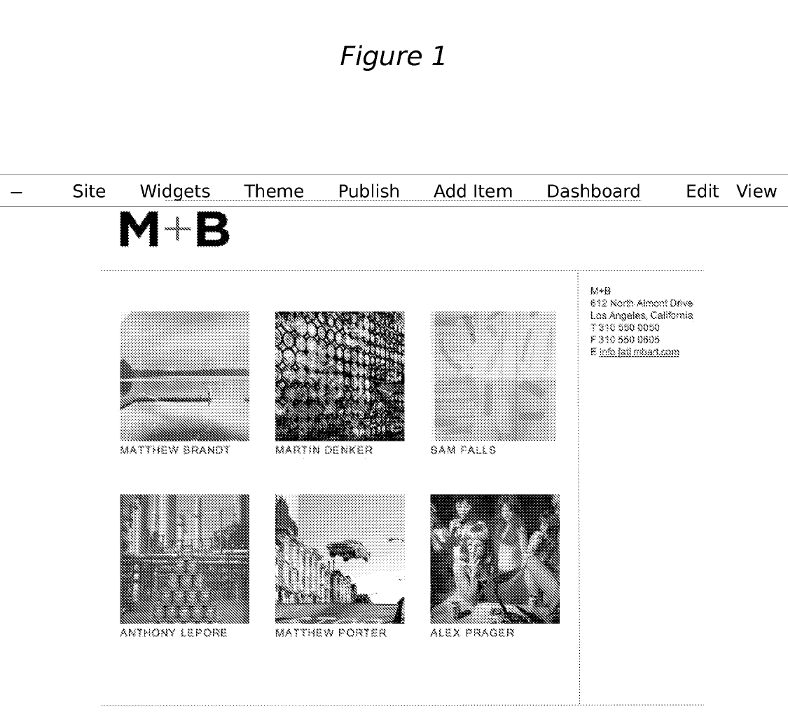

FIG. 2 is one example of a property palette for a text-based widget.

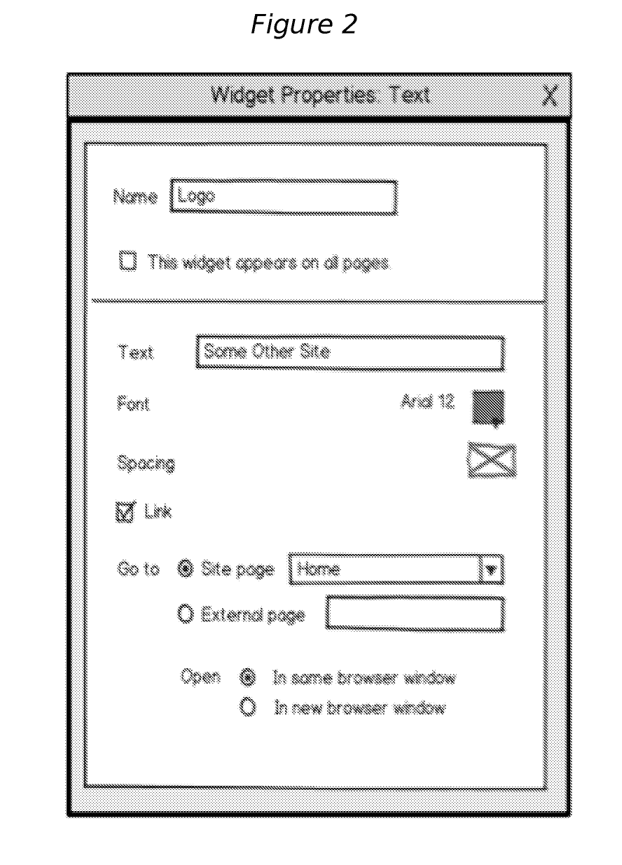

FIG. 3 shows illustrative html code for a particular example of a theme for a widget illustrating the complexity of the code.

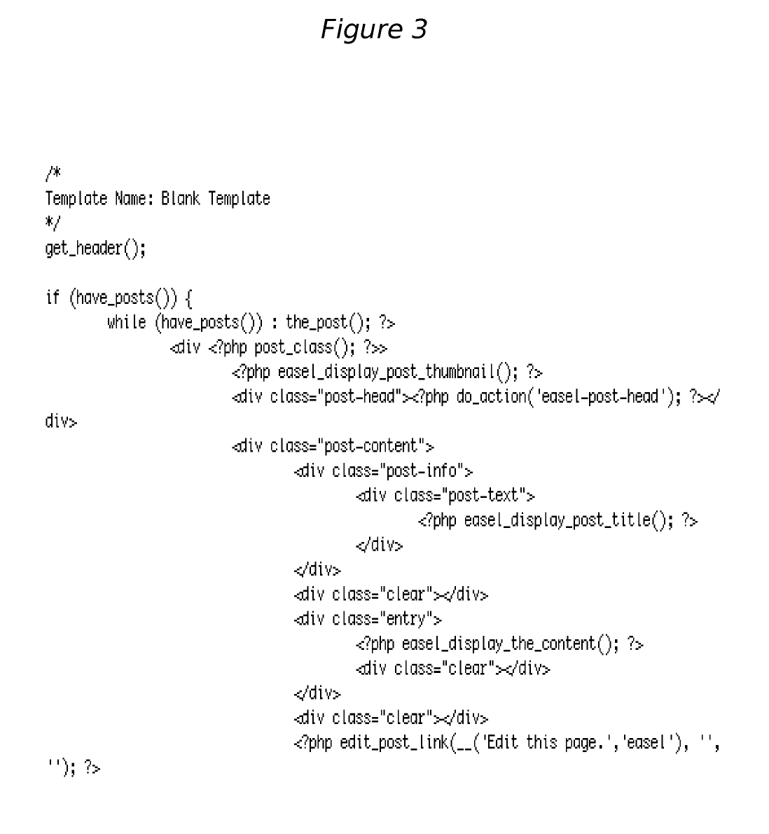

FIG. 4 is an example of a grid item template constructed in accordance with the teachings of the present invention.

FIG. 5 is an example of a grid detail page template constructed in accordance with the teachings of the present invention.

FIG. 6 is an example of an item description property palette constructed in accordance with the teachings of the present invention.

FIG. 7 is an example of a grid widget property palette constructed in accordance with the teachings of the present invention.

### DETAILED DESCRIPTION OF EMBODIMENTS

Widget-based website developing tools have used a combination of script-based “themes” and user-modifiable property palettes to modify the parameters of the widget elements of a hosted website. The themes specify the overall look and feeling of the site itself and the various widgets; the properties palettes allow a user to specify some, but not all of these elements.

Generally stated, the embodiments described herein allow the look and feel of the widgets themselves to be defined visually, using “child widgets” to define the look and feel of the “parent widgets.” This approach may result in very significant time savings and productivity gains compared to other methods of website development.

These embodiments are the first comprehensive solution to the templating and theme editing problem for websites. In the preferred embodiment, there is no hard coded “theme” file that defines the overall website look and feel. Instead, each widget may be defined visually using one or more “child widgets” that define the look and feel of the widget itself as well the look and feel of any associated page that is linked to the widget (for example, the detail page that is displayed when the user clicks on an individual grid item).

Certain embodiments may use two or more generations of widgets. For example and without limitation, in ascending hierarchical order, there may be child widgets, parent widgets, and “grandparent” widgets, wherein the grandparent and parent widgets have a parent-child relationship and the parent widget may be used as a “child” widget in relation to the grandparent widget—which would be the “parent” widget in that particular relationship.

As described herein, in one embodiment, a theme comprises widget property settings for each widget used to create a website, templates that define the look and feel for each widget used to create the website, and the one or more pages associated with the website.

In the preferred embodiment, there may be one or more templates; a template being a standard version of a particular parent widget. A template page may display a template, along with a selection of one or more child widgets, wherein each of the one or more child widgets may be used as a component of the parent widget. There may be a template page associated with each template. Each template page may be accessed in a tree or list format. Clicking on any node of that tree may bring up the template to be edited. This template may be shown in a separate window, along with the various child widgets that may be used to define the parent widget.

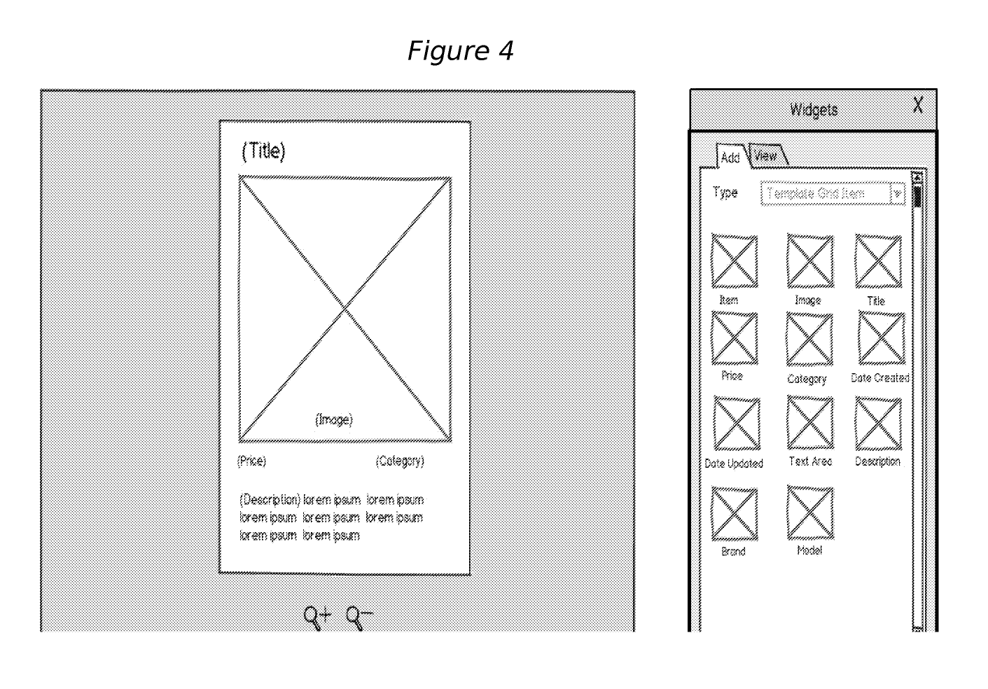

FIG. 4 illustrates one embodiment of a grid item template, which is a template for an item in a grid that is displayed on a page. In the example shown in FIG. 4, the grid item template is being edited. The child widgets that may define this grid item template may include, without limitation, the title, image, price, category and description. Further child widgets can be added by clicking or dragging items from the widget palette. Items can be moved around or deleted with the delete key, a button, or a trash can.

In the embodiment shown in FIG. 4, once the template for the grid item has been defined, the resulting grid item widget can be displayed on any page in the website. Another widget (a “grid widget”) may comprise one or more grid item widgets, so that a page containing the grid widget may display a number of items sequentially, with a fixed number per row, and pagination controls.

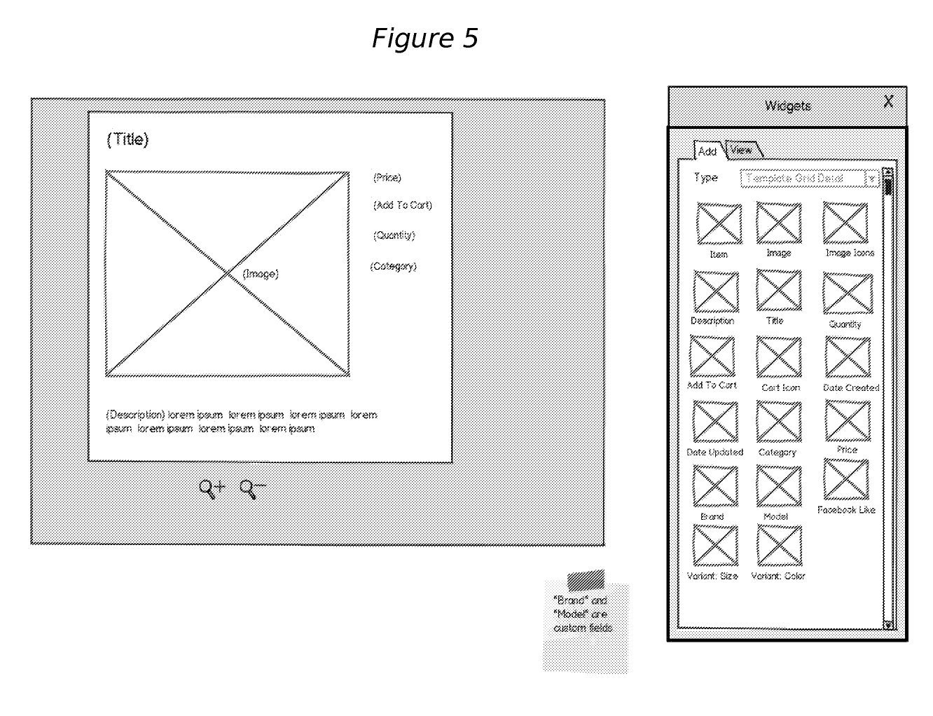

Furthermore, each grid item widget may provide a link to a grid detail page which is displayed after the link has been clicked on. One example template for a grid detail widget used to create a grid detail page is shown in FIG. 5.

FIG. 5 illustrates one embodiment of a grid detail page template. Like the previous example shown in FIG. 4 and described above, the grid detail page template in FIG. 5 may be defined with various “child widgets” that are used to specify the template. Without limitation, these child widgets may include a static text or static image widget, and an item description widget. The item description widget may retrieve its text from a dataset (e.g., a table of data) associated with a grid. The item description widget may display the text in a manner specified by a property palette associated with the item description widget.

### Association of Templates and Widgets

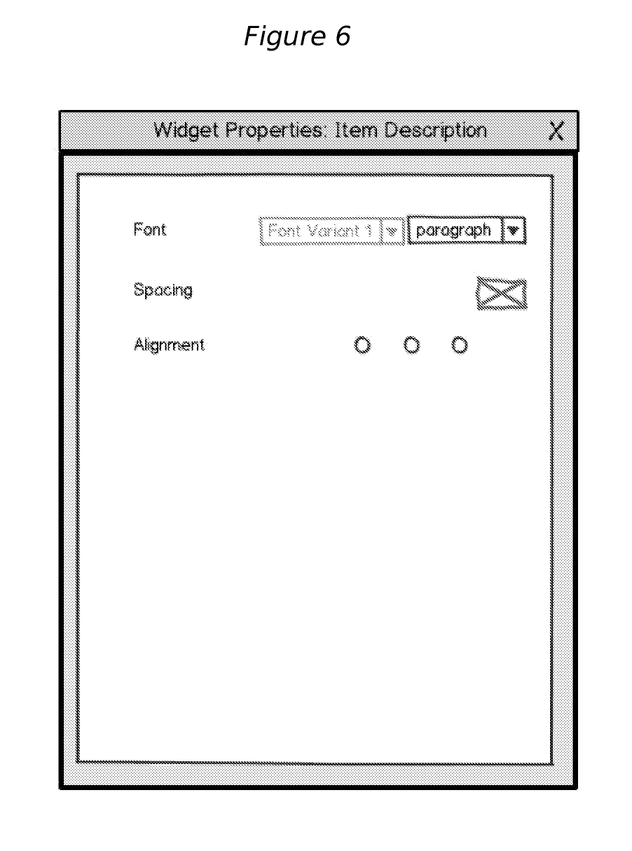

FIG. 6 illustrates one embodiment of an item description property palette. There are several ways a template can be associated with a specific widget. In one embodiment, the widget itself can specify the template that is used to define it. This may be done in the property palette of the widget. (In the example illustrated in FIG. 6, the font variant menu may be grayed out if only one variant exists.)

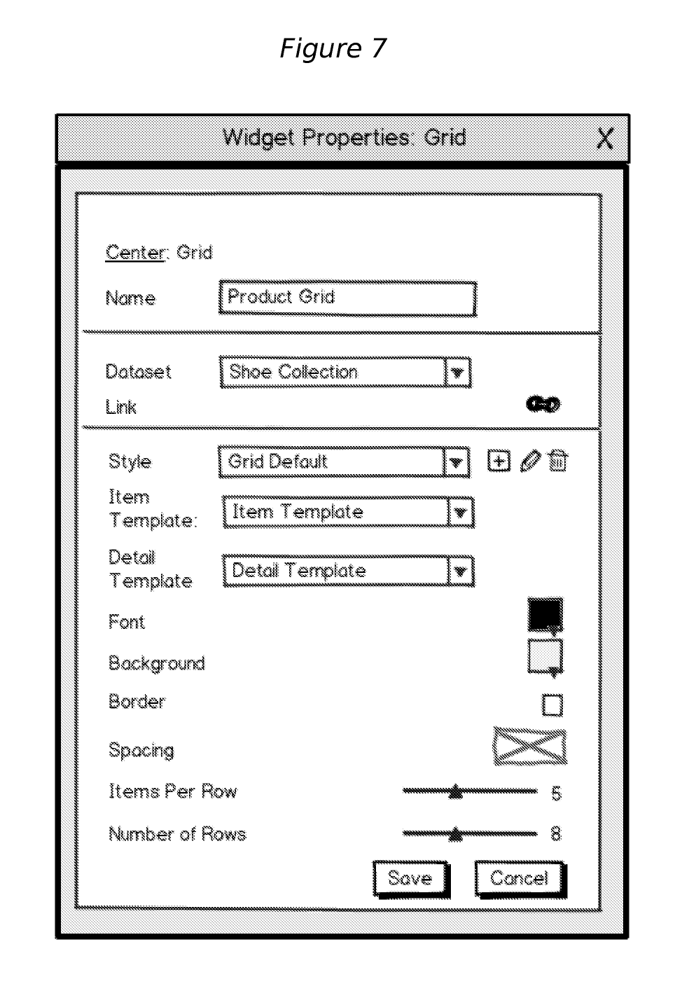

FIG. 7 illustrates one embodiment of a grid widget property palette. In FIG. 7, the grid widget property palette specifies that the grid items associated with the grid widget are defined by the template “Item Template.” In this embodiment, the grid widget property palette further specifies that the “Detail Template” defines the particular page to which each particular grid item links when that particular grid item is clicked on.

### Definition of Themes

Embodiments allow a user to define a theme file completely in terms of one or more widgets and one or more templates. For example, a theme file may comprise the following:
the regions of each page;
data regarding the one or more widgets used in connection with one or more regions of one or more pages, along with the properties of each of the one or more widgets; and
data regarding one or more templates used by each of the one or more widgets.

Certain embodiments may provide a one-to-one correspondence between the visual look and feel of the website and the theme file. Users can change any element of a theme simply by dragging and dropping “child” widget elements—and they can save their changes and create their own re-usable themes.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention is:

1. A system for creating website themes, the system comprising:
a website development tool, the website development tool being a multi-tiered widget-based tool, wherein a page of the website is defined through the use of two or more widgets, at least a first widget being a parent widget and at least a second widget being a child widget, the parent widget and the child widget being programmatically associated such that the child widget affects properties of the parent widget.

2. The system recited in claim 1, wherein the website development tool executes on website development server, and further wherein the website development server makes available a theme file that defines a layout of the website.

3. The system recited in claim 2, wherein the theme file comprises:
a first component that defines regions of at least one page of the website;
data regarding a plurality of widgets used in connection with one or more regions of the at least one page of the website, at least one of the widgets in the plurality of widgets having a parent/child relationship with at least another of the plurality of widgets;
data regarding properties of each of the widgets in the plurality of widgets; and
data regarding one or more templates used by each of the plurality of widgets.

4. The system recited in claim 1, wherein the website development tool enables a drag-and-drop creation of the page such that each of the plurality of widgets is dragged to a location on a conceptual page, and further wherein dragging a first widget and dropping the first widget onto a second widget establishes a parent/child relationship between the first and second widgets.

5. A theme file for defining a website layout, the theme file comprising:
a first component that defines regions of at least one page of the website;
data regarding a plurality of widgets used in connection with one or more regions of the at least one page of the website, at least one of the widgets in the plurality of widgets having a parent/child relationship with at least another of the plurality of widgets;
data regarding properties of each of the widgets in the plurality of widgets; and
data regarding one or more templates used by each of the plurality of widgets.

6. The theme file recited in claim 5, wherein at least on child widget is associated with a parent widget, and further wherein the child widget affects properties of the parent widget.

7. A method for creating website themes, the method steps comprising:
creating a website by defining at least one page of the website using a plurality of widgets, at least two widgets having a parent/child relationship, a child widget affecting properties of the parent widget.

8. The method recited in claim 7, wherein a look and feel of the website is defined by using the child widget to define the properties of the parent widget.
